(19) United States
(12) Patent Application Publication
(10) Pub. No.: US 2007/0054639 A1
(43) Pub. Date: Mar. 8, 2007

(54) Apparatus and method for improving the reception of an information signal

(76) Inventor: Mark A. Bauman, College Place, WA (US)

Correspondence Address: MARK ALLISON BAUMAN, 1910 SUNFLOWER COURT, COLLEGE PLACE, WA, 99324, US

(21) Appl. No.: 11/221,093

(22) Filed: Sep. 6, 2005

(51) Int. Cl. H04B 1/10

(52) U.S. Cl. 455/222

(57) ABSTRACT

The present invention is an apparatus and method for improving the reception of a first radio signal by receiving the first radio signal at a first frequency using a first modulation scheme and transmitting the information gleaned or received from the first radio signal onto a second radio signal at a second frequency using a second modulation scheme so it can be received in an improved manner on another receiver. Provision is made in the present invention to select the first frequency and the second frequency using a remote commander. One embodiment of the present invention utilizes an antenna that is substantially sensitive to the magnetic component of an electromagnetic wave for reception of the radio signal. Another embodiment includes a motor which is operable to rotate the antenna to improve signal reception in response to signals provided by the remote commander.

### BACKGROUND OF THE INVENTION

1. Field of the Invention

The present invention relates in general to a method and apparatus for improving the reception of radio signals and more particularly concerns a method of receiving a radio signal modulated with a first modulation scheme at one frequency and transmitting the information from that signal at a second frequency using a second modulation scheme, and more particularly concerns a method and apparatus for receiving a radio signal with an antenna that is substantially sensitive to the magnetic component of an electromagnetic wave and retransmitting the content of the radio signal at another frequency.

2. Description of Related Art

Broadcast radio receivers for the long, medium wave and the short wave bands have been used for many years as a means of disseminating entertainment and information to the public. In recent years, an increasing amount of interference has hindered the reception of long, medium and short wave broadcast signals especially when the antennas included with the receivers are located in the interior of a building. There are many known interference sources to broadcast signals including fluorescent lights, switching power supplies, computers, and electronic power controllers. In addition, long and medium wave receivers are often located proximate or coincident to audio-visual equipment that can produce additional interference that degrades the received signal quality.

It is known in the art that some types of antennas are more effective at rejecting interference than other antennas. For example, loop antennas are less prone to interference because they are known to be substantially sensitive to the magnetic component of electromagnetic waves and substantially insensitive to the electric component of an electromagnetic wave. This property is useful for reducing interference from many sources that are proximate to the antenna. In addition, loop antennas may be designed to provide a bidirectional null response pattern that enables a user to reduce the level of interference by orienting the antenna so that the null of the antenna is directed towards the source of the interference.

Broadcast signals in the long, medium and short wave bands are also attenuated within buildings. This is especially true in many structures and buildings with metal framework that acts to shield the interior sections of the building from long, medium, and short wave radio signals.

The combination of increasing interference from the interference sources combined with the increased attenuation of electromagnetic waves reduces the signal to noise ratio of long, medium, and short wave radio signals within buildings and has hindered their popularity in some parts of the world.

One method known in the art for improving the reception of radio signals over a geographic area is to employ a radio repeater which converts a radio signal at one frequency and to a radio signal on another frequency. These repeaters are often employed in the very high frequency and ultra-high frequency portions of the radio spectrum to increase the geographical coverage of a radio system. However, current repeater offerings are not useful in alleviating the interference and attenuation problems experienced with the long, medium and short wave broadcast medium due to their common mode conversion, large size, expense, external antennas, cumbersome setup, and maintenance which exceeds the capability of a casual user.

In addition, many long, medium, and short wave radio receivers and broadcasts have limited bandwidth, which restricts their fidelity, or their ability to reproduce the original signal. More recently, various digital modulation and demodulation schemes have been proposed, and are being adopted, which promise to substantially improve the fidelity of long, medium, and short wave broadcasts. However, reception of these digital modulation schemes often requires the disposal of current radio receivers and purchase of a new, more expensive, radio receivers.

While long, medium, and short wave broadcasts have declined in popularity in some countries, frequency modulated broadcasts have gained in popularity and frequency modulated receivers are readily available due in part to their high fidelity, relatively superior noise immunity, small size, low cost, and ability to be mass-produced.

What is needed is an integrated, low-cost, and effective apparatus and method for improving the fidelity and reception of long, medium, and short wave radio signals in various locations including buildings, which leverage the fidelity and popularity of frequency modulation broadcast receivers, and is the subject of the present invention.

### SUMMARY OF THE INVENTION

A first aspect of the present invention relates to an apparatus for improving the reception of an information signal modulated on a first electromagnetic wave having an electric and magnetic component, having a first frequency, and comprising; a receiving antenna located in intercepting relation to the first electromagnetic wave and configured to transform the first electromagnetic wave into a first signal; a radio frequency receiver tuned to the first frequency, and coupled to the first signal, and configured to demodulate the first signal to provide a second signal which is an approximate reproduction of the information signal; a radio frequency transmitter coupled to the second signal, and operable to create a periodic waveform at a second frequency and modulate the periodic waveform by the second signal to form a third signal; a second antenna coupled to the third signal and configured to transform the third signal into a second electromagnetic wave; a controller coupled to the radio frequency receiver and the radio frequency transmitter, and operable to set the first and the second frequencies in response to a first frequency command and a second frequency command; a user operable command transmitter located at a distance from the command receiver, and configured to provide a third electromagnetic wave modulated by the first frequency command and the second frequency command in response to stimulus from a user; and a command receiver coupled to the controller and configured to capture the first frequency command and the second frequency command modulated on the third electromagnetic wave.

Another aspect of the present invention relates to an apparatus for improving the reception of an information signal modulated on a first electromagnetic wave having an electric and magnetic component, and having a first frequency, comprising; a means for receiving at the first frequency the first electromagnetic wave to provide a first signal which is an approximate reproduction of the information signal; a means for transmitting a third signal by modulating a second signal having a second frequency by the first signal; a means for controlling the first frequency of the receiving means in response to a first command; a means for controlling the second frequency of the transmitting means in response to a second command; a means for sending the first and second of commands on a third electromagnetic wave in response to stimulus provided by a user; and a means for sensing the first and second of commands that have been modulated on the third electromagnetic wave.

Still further, another aspect of the present invention relates to a method for improving the reception of a first radio signal having a first frequency, which includes the steps of; providing a remote commander operable to send a plurality of commands in response to stimulus provided by a user that includes a receive frequency command and a transmit frequency command; providing a retransmission module located at a distance from the remote commander and operable to receive and respond to the plurality of commands sent by the remote commander, and further operable to extract an information signal received from the first radio signal when the retransmission module is tuned to the first frequency, and further operable to transmit a second radio signal that is encoded with the information signal, and wherein the second radio signal has an average frequency that is equal to a second frequency, and sending the receive frequency command from the remote commander in response to stimulus provided by a user; receiving the receive frequency command with the retransmission module, and tuning the transmission module in response to the receive frequency command to the first frequency to enable reception of the first radio signal; sending the transmit frequency command from the remote commander in response to stimulus provided by a user, and receiving the transmit frequency command with the retransmission module; adjusting the transmission module in response to the transmit frequency command to transmit the second radio signal at an average frequency substantially equal to the second frequency; extracting the information signal received by the retransmission module from the first radio signal; and synthesizing the second radio signal in the retransmission module by encoding the information signal at an average frequency that is substantially equal to the second frequency, and transmitting the second radio signal from the retransmission module.

### BRIEF DESCRIPTION OF THE DRAWINGS

Preferred embodiments of the invention are described below with reference to the following accompanying drawings.

FIG. 1 is a perspective drawing of the invention including a partial cutout of an enclosure to provide a partial fragmentary view the internal components of a retransmission module.

FIG. 2 is a system level simplified block diagram of the invention.

FIG. 3 is a simplified operational flow chart of the invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

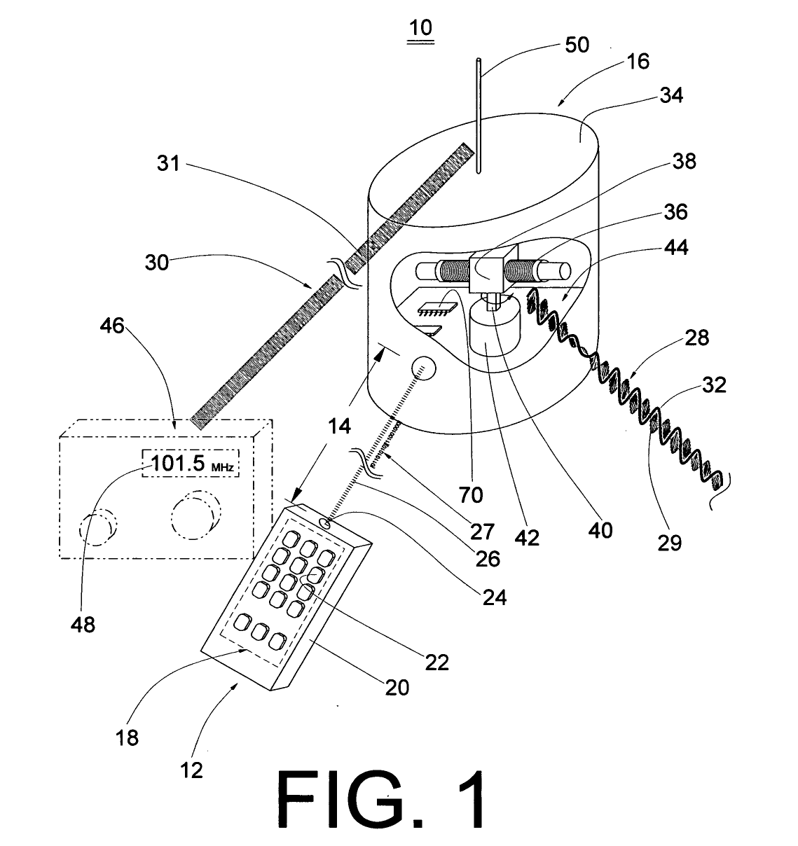

Referring to FIG. 1, an apparatus for improving the reception of an information signal 10 includes a remote commander or user operable command transmitter 12 positioned at a distance generally indicated by the numeral 14 from a retransmission module 16. An information signal 32 is modulated on a radio wave or receive electromagnetic wave 28 that is composed of both electric and magnetic components, and has a frequency graphically represented and indicated by the numeral 29.

The retransmission module 16 is positioned in receiving relation to the radio signal or receive electromagnetic wave 28. The receive electromagnetic wave 28 has the frequency 29 and is modulated by the information signal 32 from a remote transmitter (not shown). In one embodiment, the receive electromagnetic wave 28 is an amplitude modulated radio wave with a frequency that lies within the medium wave broadcast band as recognized by many countries throughout the world. This medium wave broadcast band in the United States has a frequency range between 530 KHz and 1700 KHz. It should be understood that there are a plurality of modulation schemes, both analog and digital, which are employed by broadcasters around the world that could be received by the retransmission module 16.

The retransmission module 16 is positioned in transmitting relation to another electromagnetic wave generally designated by the numeral 30. The transmit electromagnetic wave 30 has a second or transmit frequency 31 that is distinct from the receive frequency 29 of the electromagnetic wave 28. The electromagnetic wave 30 is modulated with a signal that is a substantial duplicate of the information signal 32. The transmit electromagnetic wave 30 is configured to propagate from the retransmission module 16 to a broadcast receiver 46. The broadcast receiver 46 has a broadcast receiver frequency 48 which reflects the tuning frequency of the receiver 46. The broadcast receiver frequency 48 should substantially match the frequency 31 of the transmit electromagnetic wave 30 in order to substantially reproduce the information signal 32 modulated on the receive electromagnetic wave 28. In one embodiment, the transmit electromagnetic wave 28 is frequency or phase modulated by a signal that is a substantial duplicate of the information signal 32, and the transmit electromagnetic wave 28 has an average frequency 31 which lies within the frequency modulated broadcast band, and the broadcast receiver 46 is a consumer grade FM radio receiver. In the United States, the frequency modulated broadcast band lies between 88 MHz and 108 MHz.

The user operable command transmitter 12 is commonly referred of in the art as a remote control and generates command signals that are transmitted as a modulated control electromagnetic wave 26 in response to stimulus by a user (not shown). The user operable command transmitter 12 is positioned within a distance (not shown) of the broadcast receiver 46 so that sound from the broadcast receiver 46 is capable of being heard by the user (not shown). The user operable command transmitter 12 includes a keypad 18 and a housing 20. The keypad 18 includes a plurality of pushbuttons 22 which provide a means for entry of user desired values to select a receive frequency 29 which corresponds to the frequency of the electromagnetic wave 28, and to select a transmit frequency 31 which corresponds to the frequency of the transmit electromagnetic wave 30. It will be appreciated that the transmit frequency 31 should substantially match the broadcast receive frequency 48. Various types of entry are compatible with the arrangement shown, including direct entry, incremental, decremental, or scan. The user operable command transmitter 12 generates the control electromagnetic wave 26 that carries command signals 27 which reflect the user stimulus of the keypad 18. The control electromagnetic wave 26 travels or propagates through an aperture or window 24 in the housing 20. The control electromagnetic wave 26 travels or propagates the distance 14 to the retransmission module 16. In one embodiment, the control electromagnetic wave 26 is an infra-red optical emission having a wavelength between 750 nm and 1000 nm, modulated at a frequency of approximately 40 KHz with the commands encoded using a pulse length coding scheme that is well known in the art. Other methods of coding may be used without departing from the scope of the invention.

Referring still to FIG. 1, the retransmission module 16 contains electronic circuitry to demodulate the receive electromagnetic wave 28 at the receive frequency 29 to provide a substantial duplicate of the information signal 32, and to generate the transmit electromagnetic wave 30 to carry the substantial duplicate of the information signal 32 at the transmit frequency 31 to the broadcast receiver 46. In addition, the retransmission module 16 contains electronic circuitry to receive and decode command signals 27 from the user operable command transmitter 12 to select the receive frequency 29 and the transmit frequency 31. The retransmission module 16 is positioned in a location where the receive electromagnetic wave 28 propagates and provides best results when its location has less interference than the location of the broadcast receiver 46.

The retransmission module 16 is a housed in an enclosure 34. At least a portion of the enclosure 34 is constructed of material that permits the receive electromagnetic wave 28 to penetrate its surface. A receive antenna 36 is located within the enclosure 34, and is positioned in a manner so that it can intercept or receive the receive electromagnetic wave 28. In one embodiment, the receive antenna 36 is a loop antenna which is known in the art to be substantially sensitive to the magnetic portion of the electromagnetic wave 28. Other types antennas that are substantially sensitive to the magnetic portion of electromagnetic waves may be utilized as the receive antenna 36 without departing from the scope of the invention. For example, a wire loop antenna, coaxial loop antenna, pancake loop antenna, and shielded loop antenna may be used.

In one embodiment, the receive antenna 36 is borne by a coupler 38. The coupler 38 is attached to a shaft 40. The shaft 40 is rotated by a motor 42. In this embodiment, the motor is operable to rotate the receive antenna 36 in response to stimulus provided by the user operable command transmitter 12. The motor 42 is borne by a circuit board assembly 44.

The electronic circuitry of the circuit board assembly 44 includes receiving circuitry for demodulating the receive electromagnetic wave 28, transmitting circuitry for transmitting the transmit electromagnetic wave 30, the circuitry for receiving and processing the control electromagnetic wave 26, and others which will be described in further detail below.

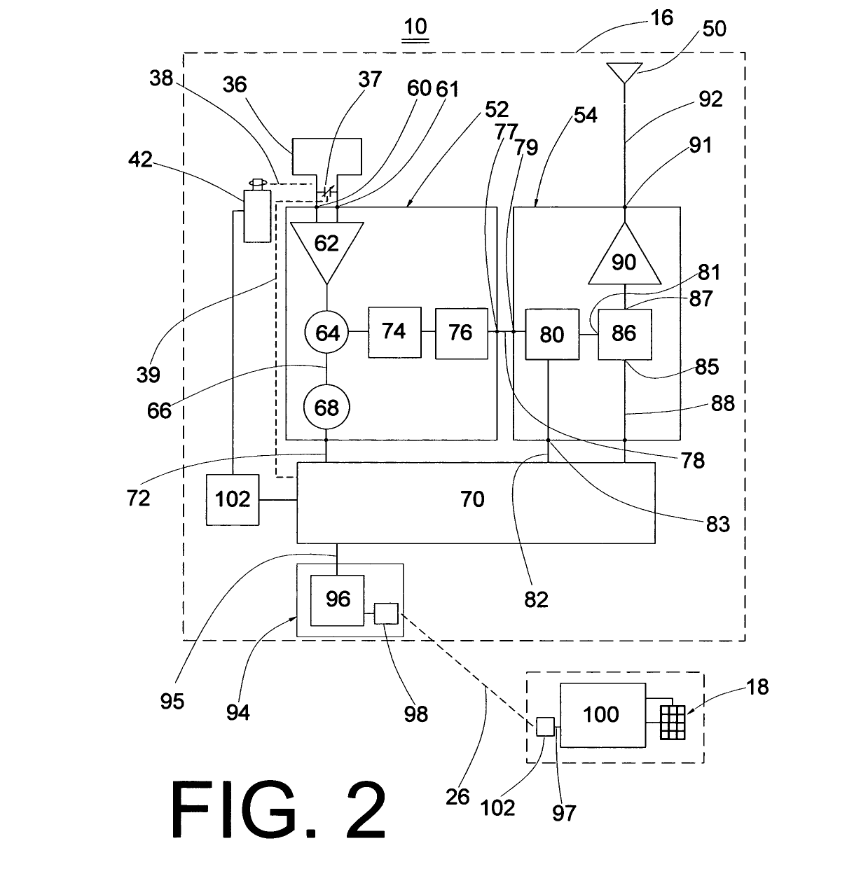

Referring now to FIG. 2, the retransmission module 16 is connected in receiving relation to the user operable command transmitter 12 by means of the control electromagnetic wave 26.

In the retransmission module 16, the receive antenna 36 is connected in a parallel combination with a variable capacitor 37. The combination of the receive antenna 36 and the variable capacitor 37 form a parallel resonant circuit. The capacitance value of the variable capacitor 37 is selected by an antenna tuning control signal 39. The variable capacitor 37 may be formed using a single or pair of variable capacitance diodes in combination with appropriate coupling components known in the art. For optimum results, the resonant frequency of the parallel combination of the receive antenna 36 and the variable capacitor 37 should approximate the receive frequency 29.

The receive antenna 36 is connected to the signal input 60 and 61 of a radio frequency receiver 52. The radio frequency receiver 52 is also connected to a receive frequency control signal 72 provided by a controller 70. The receive frequency control signal 72 is operable to select the frequency of reception, or to control the tuning, of the radio frequency receiver 52 to the receive frequency 29. The radio frequency receiver 52 provides an output signal 78 which is an extract, or approximate duplication, of the information signal 32. The information signal 32 includes a mono or stereo audio signal. In one embodiment, the radio frequency receiver 52 is configured to demodulate amplitude modulated signals. In another embodiment, the radio frequency receiver 52 is configured to decode digitally encoded radio signals. One skilled in the art will recognize that other demodulation schemes may be employed in the radio frequency receiver 52 which can include both analog and digital modes.

Referring still to FIG. 2, a radio frequency transmitter 54 has an input 79 which is connected in signal transferring relation to the output 77 of the radio frequency receiver 52. The input 79 is configured to accept mono or stereo audio signals from the output 77. The radio frequency transmitter 54 has a second input 83 that accepts an enunciator signal 82 that is superimposed on the signal at the input 79. The enunciator signal 82 is useful to provide information to the user (not shown) regarding the operational status of the retransmission module 16. The operational status may include indication of the current receive frequency 29, transmit frequency 29, or the orientation of the antenna 36.

The radio frequency transmitter 54 has the transmit frequency 31 and is controlled by a transmit frequency control signal 88. The radio frequency transmitter 54 produces an output 91 that provides a signal 92. The signal 92 is fed to the transmit antenna 50. The signal 92 is a radio frequency signal produced by the radio frequency transmitter 54 and includes modulation components representing the signal 78 and the signal 82. In one embodiment, the signal 92 has the characteristics of a wide band frequency modulated signal with a frequency deviation of 100 KHz. One skilled in the art will recognize that other modulation methods may be employed in the radio frequency transmitter 54 which include both analog and digital techniques.

Referring still to FIG. 2, the radio frequency receiver 52 includes a front-end amplifier 62. The output of the front-end amplifier 62 is connected to one port of a receive mixer 64. Another port of the receive mixer 64 is connected to the output of a receive frequency synthesizer 68. The receive frequency synthesizer 68 is controlled by the first frequency control signal 72. The receive mixer 64 has an output connected to one port of a band-pass Filter 74. The opposite port of the band-pass filters 74 is connected to the input of a demodulator 76. The output of the demodulator 76 forms the output 77 of the radio frequency receiver 52. In one embodiment, the demodulator 76 is a analog precision rectifier which is useful for demodulating amplitude modulated signals. Alternatively, the demodulator may be a synchronous detector, a quadrature demodulator combined with a codec, or any other type of demodulator known in the art which may be useful for demodulating or decoding information from the receive electromagnetic wave 28. One skilled in the art would readily recognize that there are many techniques for implementing the radio frequency receiver 52 which could be similarly implemented without departing from the scope of this invention.

The input 79 of the radio frequency transmitter 54 is connected to the input of a signal combiner 80. The signal combiner 80 has another input connected to the input 83 of the radio frequency transmitter 54. The signal combiner 80 combines signals from the input 79 and the input 83 by superposition. The output of the combiner 80 is connected to a modulation input 81 of a frequency modulation synthesizer 86. The modulation input 81, and is operable to control the frequency deviation and modulation level of the frequency modulation synthesizer 86. The frequency modulation synthesizer 86 has a frequency control input 85 that is operable to control the center or average frequency generated by the synthesizer 86 which corresponds to the transmit frequency 31. The frequency control input 85 is connected to the transmit control signal 88. The frequency modulation synthesizer 86 has an output 87 that represents a frequency modulated signal that is modulated by the signal 78 and the signal 82. The output 87 is connected to an input of a final amplifier 90. A signal 92 is present at the output of the final amplifier 90. The signal 92 is connected to the second transmit antenna 50. The output level of the final amplifier 90 is set to conform to limits set by the regulatory authority having jurisdiction in the area where the invention 10 is implemented. One skilled in the art would readily recognize that there are many techniques for implementing the radio frequency transmitter 54 which could be similarly implemented without departing from the scope of this invention.

Referring still to FIG. 2, the user operable remote transmitter 12 includes the keypad 18, a command modulator 100, and transducer 102. The command modulator 100 is operable to respond to user stimulus or input from the keypad 18 to provide command signals 27 (FIG. 1) on wire 97 which are transmitted by the transducer 102. The transducer 102 provides the control electromagnetic wave 26 that is generated from the command signals 27 (FIG. 1) provided by the command modulator 100. In one embodiment, the signals transmitted by the transducer 102 are pulse length coded using a carrier frequency of approximately 40 KHz, and transducer 102 is an infrared light emitting diode.

Referring still to FIG. 2, a command receiver 94 includes a signal conditioner 96 and a sensor 98. In one embodiment, the command receiver 94 is an infrared demodulator capable of decoding pulse coded modulated signals having a carrier frequency of approximately 40 KHz.

It will be appreciated by one skilled in the art that the command receiver 94 and the user operable command transmitter 12 represent a remote control system. This remote control system may be practiced in a variety of techniques including radio frequency, microwave control, or network systems that are known in the art.

Referring still to FIG. 2, a controller 70 is connected in receiving relation to command signals 27 (FIG. 1) captured by the command receiver 94 by wire 95. The controller 70 is configured using an embedded control program to decode the command signals 27 (FIG. 1) and provide control signals for use within the retransmission module 16.

The controller 70 is operable to provide the antenna tuning signal 39 which controls the setting of the capacitance value of the variable capacitor 37 in response to the command signals 27 (FIG. 1) decoded by the controller 70. The controller 70 is also operable to provide the receive frequency control signal 72 to the radio frequency receiver 52 in response to the command signals 27 (FIG. 1) decoded by the controller 70. The controller 70 is also operable to provide the enunciator signal 82 to the radio frequency transmitter 54. The controller 70 is also operable to provide the transmit frequency control signal 88 to the radio frequency transmitter 54 in response to the command signals 27 (FIG. 1) decoded by the controller 70.

In one embodiment, the controller 70 is connected to a motor driver 102. The motor driver contains power electronics capable of driving the motor 42. As previously discussed, the motor 42 is operable to rotate receive antenna 36 in response to command signals 27 (FIG. 1) decoded by the controller 70.

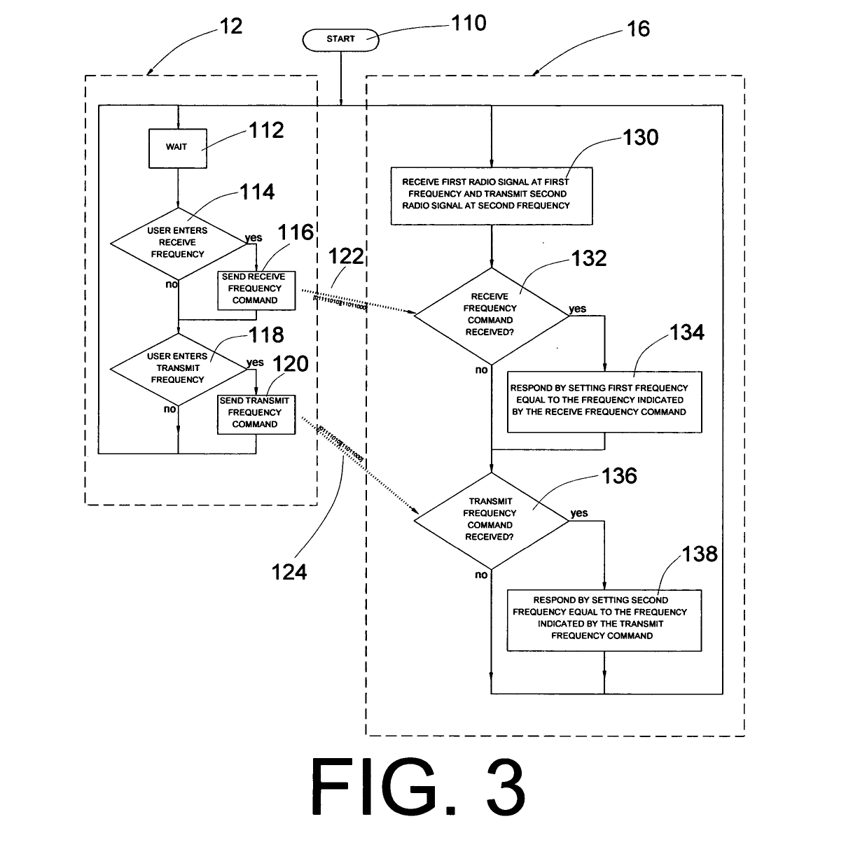

Referring now to FIG. 3, the remote commander or user operable command transmitter 12 and the retransmission module 16 each include a plurality of process steps which will now be discussed below. The process for both the user operable command transmitter 12 and the retransmission module 16 start at step 110.

The simplified process steps performed by the user operable command transmitter 12 proceed to a wait step 112. The wait step 112 is followed by a receive frequency user entry step 114. If the receive frequency is entered, then the process transfers to the send receive frequency command step 116. During the send receive frequency command step 116, a receive frequency command 122 is sent to the retransmission module 16. The receive frequency command step 116 is one of the plurality of command signals 27 (FIG. 1) that are sent via the control electromagnetic wave 26 (FIG. 1). If no entry is made by the user, or when step 116 is complete, the process transfers to the transmit frequency user entry step 118. If the transmit frequency is entered, then the process transfers to the send transmit frequency command step 120. During the send transmit command step 118, a transmit frequency command 124 is sent to the retransmission module 16. The transmit frequency command 124 is one of the plurality of command signals 27 (FIG. 1) that are sent via the control electromagnetic wave 26 (FIG. 1). If no entry is made by the user, or when step 120 is complete, the process returns to the wait step 112.

The simplified process steps performed by the retransmission module 16 proceeds from the start step 110 to the retransmission step 130. The retransmission step 130 includes the process of receiving a first radio signal at a first frequency and transmitting the information received from the first radio signal on a second radio signal at a second frequency. During the retransmission step 130, a determination is made in step 132 to ascertain whether the receive frequency command 122 was received. If the receive frequency command 122 is received in step 132, then the retransmission module 16 responds with step 134 which includes setting the first frequency equal to the frequency indicated by the receive frequency command 122. If no receive frequency command 122 is received in step 132, or after the response of step 134 is complete, then a determination is made in step 136 to ascertain whether the transmit frequency command 124 was received. If the transmit frequency command 124 is received in step 136, then the retransmission module 16 responds with step 138 which includes setting the second frequency equal to the frequency indicated by the transmit frequency command 124. If no transmit frequency command 124 is received in step 136, or after the response of step 138 is complete, then the process continues at step 130. It should be understood that the step 130 is concurrent and not significantly interrupted during steps 132 and 136.

In one embodiment, the first radio signal is a medium wave broadcast signal and the second radio signal is a local FM (frequency modulated) signal located within the FM broadcast range of frequencies.

### Operation

the operation of the present invention is believed to be readily apparent and is briefly summarized in the paragraphs which follow.

The retransmission module 16 is positioned in a location which is suitable for receiving the receive electromagnetic wave 28. For example, the location of the retransmission module 16 may be in a building (not shown) near an opening in the building such as a window. In this location, the receive electromagnetic wave 28 may be stronger than other areas of the building away from an opening or further into the interior areas of the building. In addition, interference from a variety of sources may be at lower level near the perimeter of a building relative to those that might be experienced in its interior. The user (not shown) may be positioned within the interior of the building and hold the user operable command transmitter 12 located at the distance 14 from the retransmission module. The broadcast receiver 46 is positioned within audible range of the user.

The present invention includes a method for improving the reception of the first radio signal or receive electromagnetic wave 28 at the receive frequency 29. The method includes providing the remote commander or user operable command transmitter 12 operable to send the plurality of commands or command signals 27 in response to stimulus provided by a user. The method includes steps 132 and 136 by providing a command receiver 94 operable to receive the plurality of command signals 27 from the remote commander or user operable command transmitter 12. The user (not shown) in step 114 selects the receive frequency 29 by entering, or otherwise selecting, the value of the receive frequency 29 into the remote commander or user operable command transmitter 12. The method further includes the step 116 of generating a receive frequency command 122 by evaluating the receive frequency 29 value entered into the remote commander or user operable command transmitter 12 and sending the receive frequency command 122 by the remote commander or user operable command transmitter 12 and receiving the receive frequency command 122 by the command receiver 94. The method further includes the step 118 which includes selecting a second or transmit frequency 31 by entering the value of the transmit frequency 31 into the remote commander or user operable command transmitter 12, the step of 120 which further includes generating a transmit frequency command 124 by evaluating the transmit frequency 31 value entered into the remote commander, sending the transmit frequency command 124 by the remote commander or user operable command transmitter 12, and the step 136 which includes receiving the transmit frequency command 124 by the command receiver 94. The method further includes the step 134 of providing the radio frequency receiver 52 tuned to the receive frequency 29 in response to the receive frequency command 122. The method further includes the step 136 of providing the radio frequency transmitter 54 tuned to the transmit frequency 31 in response to the transmit frequency command 124, providing the receive antenna 36 connected to the radio frequency receiver 52, and providing the transmit antenna 50 connected to the radio frequency transmitter 54. The method further includes receiving the first radio signal or receive electromagnetic wave 28 on the radio frequency receiver 52 to provide an information signal 32 carried by the first radio signal 28, transmitting the information signal 32 on the second radio signal or transmit electromagnetic wave 30 using the radio frequency transmitter 54, and wherein the command receiver 94, receive antenna 36, radio frequency receiver 52, and radio frequency transmitter 54 are contained together in a common enclosure 34.

In step 114 the user provides stimulus by selecting or entering the receive frequency 29 by entering or depressing the appropriate keys or pushbuttons 22 on the keypad 18 of the user operable command transmitter 12. Then, in step 118 the user provides stimulus by selecting or entering the transmit frequency 31 by pressing the appropriate keys or pushbuttons 22 on the keypad it 18 of the user operable command transmitter 12 to match the broadcast receiver frequency 48 of the broadcast receiver 46. In steps 116 and 118, the user stimulus of the user operable command transmitter 12 is converted into control signals 97 by the command modulator 100. These control signals 97 generated by the command modulator 100 are transmitted by the transducer 102 via the control electromagnetic wave 26 as one of a plurality of command signals 27. In steps 132 and 136, the control electromagnetic wave 26 is captured or received by the sensor 98. The signals received by the sensor 98 are sent to the signal conditioner 96 which demodulates the signal to provide the command signals 97. These signals are transferred to the controller 70. In steps 134 and 138, the controller 70 interprets the command signals 97 and generates the receive frequency control signal 72, the transmit frequency control signal 88, the tuning control signal 39, and the enunciator signal 82 in response to the user provided stimulus provided to the user operable command transmitter 12.

Referring to FIGS. 1-3, the retransmission module 16 is located in receiving relation to the receive electromagnetic wave 28 which carries the information signal 32 having the receive frequency 29. In step 130, the retransmission module 16 includes the radio frequency receiver 52 which is operable to receive the electromagnetic wave 28 and to provide a substantial duplicate, or extract of, the information signal 32 as the output 77. The output 77 of the radio frequency receiver 52 represents the information signal 32 of the received electromagnetic wave 28 as received on the received frequency 29. One skilled in the art would readily recognize that the received frequency 29 is selected using the user operable command transmitter 12 in the manner discussed above.

The output 77 from the radio frequency receiver 52 represents an information or audio signal 78 that is carried by the received electromagnetic wave 28. The information signal 78 is fed to the input 79 of the radio frequency transmitter 54. The signal 78 is fed bo the combiner 80 which superimposes the enunciator signal 82 provided by the controller 70 to provide an output which is delivered to the input 81 of the frequency modulation synthesizer 86. Another input 85 of the frequency modulation synthesizer is connected to the transmit frequency control signal 88 provided by the controller 70. The output 87 of the frequency modulation synthesizer 86 is delivered to the final amplifier 90. The final amplifier 90 is connected to the output 91 of the radio frequency transmitter 54 to provide the signal 92 which is sent to the transmitter antenna 50. The transmitter antenna 50 when stimulated by the signal 92 provides a transmit electromagnetic wave 30 having a transmit frequency 31 which propagates outwardly from the retransmission modules 16 and may be intercepted by a broadcast receiver 46 when the broadcast receiver frequency 48 substantially matches the transmit Frequency 31. The transmitted electromagnetic wave 30 represents a modulated waveform which carries the substantial duplicate of the information signal 78 and, during operation of the remote commander 12, the enunciator signal 82.

In one embodiment, the user may rotate or orient the receive antenna 36 by entering or selecting a direction or azimuth by using a plurality of push-buttons 22 that are located on the keypad 18 of the user operable, and transmitter 12 to provide a command signal 97 to the transmitted by the transducer 102 as the control electromagnetic wave 26 which carries the command signals 27. The control electromagnetic wave 26 is received by the command receiver 94 as discussed earlier and provided as the command signal 95 to the controller 70. The controller 70 interprets the command signals 95 and provides a direction signal to the motor driver circuit 102. The motor driver circuit 102 is operable to provide power to position or orient the motor shaft 40 in accordance with the user specified commands from the user operable command transmitter 12. In this manner, the receiving antenna 36 may be positioned or oriented to optimize the reception of the receive electromagnetic wave 28, or to reduce interference from undesirable signals.

The retransmission modules 16 includes the receive antenna 36 which is operable to intercept the receive electromagnetic wave 28. Signals from the receive antenna 36 are connected in parallel relation to the variable capacitor 37 which forms a parallel resonance circuit. The output of this parallel resonant circuit is fed to the input 60 and 61 of the radio frequency receiver 52, which is connected to the input of a front-end amplifier 62. The front-end amplifier 62 acts as a preamplifier of low-level radio frequency signals captured on the receive antenna 36. The output of the front-end amplifier 62 is mixed with a signal 66 from the receive frequency synthesizer 68 to form an intermediate frequency signal which is fed to the band-pass filter 74 and is finally demodulated in the demodulator 76. The output of the demodulator 76 is connected to the output 77 of the radio frequency receiver 52 and represents the information or audio signal 78 which is a substantial duplicate or extract of the information signal 32 carried on the receive electromagnetic wave 28.

The audio or information signal 78 is fed to the input 79 of the radio frequency transmitter 54 and is combined with the enunciator signal 82 provided by the controller 70 in the combiner 80. The output of the combiner 80 representing the superposition of the signal 78 and 82 is fed to the input 81 of the frequency modulated synthesizer 86. The frequency modulation synthesizer 86 combines the signal present at the input 81 with the frequency control signal 88 to form an output signal 87. The output signal 87 is amplified by the final amplifier 90 and presented at the output of the radio frequency transmitter 54 as the output signal 92.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. An apparatus for improving the reception of an information signal modulated on a first electromagnetic wave having an electric and magnetic component, and having a first frequency, comprising:
a receiving antenna located in intercepting relation to the first electromagnetic wave and configured to transform the first electromagnetic wave into a first signal;
a radio frequency receiver tuned to the first frequency and coupled to the first signal, and configured to demodulate the first signal to provide a second signal which is an approximate reproduction of the information signal;
a radio frequency transmitter coupled to the second signal, and operable to create a periodic waveform at a second frequency and modulate the periodic waveform by the second signal to form a third signal;
a second antenna coupled to the third signal and configured to transform the third signal into a second electromagnetic wave;
a controller coupled to the radio frequency receiver and the radio frequency transmitter, and operable to set the first and the second frequencies in response to a first frequency command and a second frequency command;
a command receiver coupled to the controller and configured to capture the first frequency command and the second frequency command modulated on a third electromagnetic wave; and
a user operable command transmitter located at a distance from the command receiver, and configured to provide the third electromagnetic wave modulated by the first frequency command and the second frequency command in response to stimulus from a user.

2. The apparatus as claimed in claim 1, and further comprising:
an enclosure;
and wherein the receiving antenna, radio frequency receiver, radio frequency transceiver, controller and command receiver are enclosed together within the enclosure.

3. The apparatus as claimed in claim 2, and wherein the receiving antenna is configured so that it is substantially sensitive to the magnetic component of the first electromagnetic wave.

4. The apparatus as claimed in claim 3, and wherein the radio frequency receiver is operable to demodulate amplitude modulated signals, and further wherein the radio frequency transmitter is operable to provide a frequency modulated signal.

5. The apparatus as claimed in claim 4, and wherein the first and the second frequency each have a value, and wherein the value of the second frequency is at least ten multiplied by the first frequency.

6. The apparatus as claimed in claim 5, and wherein the first antenna is selected from the group consisting of a wire loop antenna, ferrite loop antenna, coaxial loop antenna, pancake loop antenna, and shielded loop antenna.

7. The apparatus as claimed in claim 6, and further comprising:
a motor coupled in force transmission relation to the receiving antenna and operable to orient the receiving antenna in response to one of the plurality of commands sent by the user operable command transmitter.

8. The apparatus as claimed in claim 6, and wherein the radio frequency receiver is operable to demodulate or decode digitally encoded signals, and further wherein the radio frequency transmitter is operable to provide a frequency modulated signal.

9. The apparatus as claimed in claim 1, and wherein the radio frequency receiver is operable to demodulate amplitude modulated signals, and further wherein the radio frequency transmitter is operable to provide a frequency modulated signal.

10. The apparatus as claimed in claim 1, and wherein the receiving antenna is configured so that it is substantially sensitive to the magnetic component of the first electromagnetic wave.

11. The apparatus as claimed in claim 1, and wherein the receiving antenna is selected from the group consisting of a loop antenna, ferrite loop antenna, pancake loop antenna, and shielded loop antenna.

12. The apparatus as claimed in claim 1, and wherein the radio frequency receiver is operable to demodulate or decode digitally encoded signals, and further wherein the radio frequency transmitter is operable to provide a frequency modulated signal.

13. The apparatus as claimed in claim 1, and further comprising:
a motor coupled in force transmission relation to the receiving antenna and operable to orient the receiving antenna in response to one of the plurality of commands sent by the user operable command transmitter.

14. The apparatus as claimed in claim 1, and wherein the receiving antenna is configured to be substantially sensitive to the magnetic component of the first electromagnetic wave, and wherein the first frequency is less than two MHz, and wherein the second frequency is greater than 50 MHz.

15. An apparatus for improving the reception of an information signal modulated on a first electromagnetic wave having an electric and magnetic component, and having a first frequency, comprising:
a means for receiving at the first frequency the first electromagnetic wave to provide a first signal which is an approximate reproduction of the information signal;
a means for transmitting a third signal by modulating a second signal having a second frequency by the first signal;
a means for controlling the first frequency of the receiving means in response to a first command;
a means for controlling the second frequency of the transmitting means in response to a second command;
a means for sending the first and second of commands on a third electromagnetic wave in response to stimulus provided by a user; and
a means for sensing the first and second of commands that have been modulated on the third electromagnetic wave.

16. The apparatus as claimed in claim 16, and wherein the first electromagnetic wave is amplitude modulated, and further wherein the means for receiving comprises a means to demodulate amplitude modulated waves, and further wherein the means for transmitting comprises a means to modulate using frequency modulation.

17. The apparatus as claimed in claim 16, and wherein the means for receiving the first electromagnetic wave is substantially sensitive to the magnetic component of the first electromagnetic wave is substantially insensitive to the electric component of the first electromagnetic wave.

18. A method for improving the reception of a first radio signal having a first frequency, comprising the steps of:
providing a remote commander operable to send a plurality of commands in response to stimulus provided by a user, and wherein the plurality of commands includes a receive frequency command and a transmit frequency command;
providing a retransmission module located at a distance from the remote commander and operable to receive and respond to the plurality of commands sent by the remote commander, and further operable to extract an information signal received from the first radio signal when the retransmission module is tuned to the first frequency, and further operable to transmit a second radio signal that is encoded with the information signal, and wherein the second radio signal has an average frequency that is equal to a second frequency;
sending the receive frequency command from the remote commander in response to stimulus provided by a user;
receiving the receive frequency command with the retransmission module;
tuning the transmission module in response to the receive frequency command to the first frequency to enable reception of the first radio signal;
sending the transmit frequency command from the remote commander in response to stimulus provided by a user;
receiving the transmit frequency command with the retransmission module;
adjusting the transmission module in response to the transmit frequency command to transmit the second radio signal at an average frequency substantially equal to the second frequency;
extracting the information signal received by the retransmission module from the first radio signal;
synthesizing the second radio signal in the retransmission module by encoding the information signal at an average frequency that is substantially equal to the second frequency; and
transmitting the second radio signal from the retransmission module.

19. The method for improving the reception of the first radio signal as claimed in claim 19, and further comprising the step of:
providing an antenna located within the retransmission module and configured to intercept the first radio signal; and wherein the first radio signal has an electric and magnetic component, and further wherein the antenna is configured so that it is substantially sensitive to the magnetic component of the first radio signal, and substantially insensitive to the electric component of the first radio signal.
